(19) United States
(12) Patent Application Publication
(10) Pub. No.: US 2024/0405233 A1
(43) Pub. Date: Dec. 5, 2024

(54) Water Separation Device for a Fuel Cell, Comprising a Movable Valve Mechanism

(71) Applicant: Vitesco Technologies GmbH, Regensburg (DE)

(72) Inventors: Florian Braun, Roding (DE); Matthias Bleeck, Pentling (DE); Henry Meißgeier, Roding (DE)

(73) Assignee: Vitesco Technologies GmbH, Regensburg (DE)

(21) Appl. No.: 18/700,880

(22) PCT Filed: Oct. 11, 2022
(86) PCT No.: PCT/EP2022/078263

§ 371 Date: Apr. 12, 2024

(30) Foreign Application Priority Data
Oct. 15, 2021 (DE) 10 2021 211 698.1

(51) Int. Cl. H01M 8/04119; H01M 8/04223

(52) U.S. Cl. CPC H01M 8/04164; H01M 8/04253

(57) ABSTRACT

Various embodiments of the teachings herein include a water separation device for a fuel cell. An example includes: a separator for separating water from an aqueous gas mixture discharged from the fuel cell; a container defining a collection volume to collect the water from the separator; and a freeze protector including a displaceable valve coupled to the collection volume. When the water in the collection volume freezes, the valve moves in the direction of a freeze position enlarging the collection volume. When frozen water in the collection volume melts, the valve moves back in the direction of a melt position reducing the collection volume.

### CROSS-REFERENCE TO RELATED APPLICATIONS

This application is a U.S. National Stage Application of International Application No. PCT/EP2022/078263 filed Oct. 11, 2022, which designates the United States of America, and claims priority to DE Application No. 10 2021 211 698.1 filed Oct. 15, 2021, the contents of which are hereby incorporated by reference in their entirety.

### TECHNICAL FIELD

The teachings of the present disclosure relate to fuel cells. Various embodiments include water separation devices and/or methods for a fuel cell, which features a freeze protection mechanism with a movable valve mechanism.

### BACKGROUND

Fuel cells are also used as sources of electrical energy as part of the electrification of cars and commercial vehicles. The fuel cell is a galvanic cell in which electrical energy is obtained based on a chemical reaction between a fuel and an oxidizing agent. Hydrogen is typically used as a fuel in the motor vehicle sector. Atmospheric oxygen is used as the oxidizing agent. The fuel cell comprises two electrodes (anode and cathode) which are separated from each other by a semi-permeable membrane. The two reaction partners, fuel and oxidizing agent, are continuously fed to the electrodes. The membrane is here permeable only for one of the types of ions released during the reaction, for example protons. Electrical energy, which is used to operate the electric motors of the motor vehicle, is released during the reaction between the oxidizing agent and the fuel. In the case of hydrogen as the fuel and oxygen as the oxidizing agent, water is created as a reaction product at the cathode.

In the course of the operation of the fuel cell, nitrogen (as the main constituent of air) and water gradually diffuse from the cathode via the membrane to the anode too. This is undesirable because nitrogen and water block the ducts of the water supply system and lessen the uniform distribution of the hydrogen inside the anode, which negatively affects the efficiency of the fuel cell. In order to avoid a concentration of water in the anode and cathode, it must be evacuated from the electrodes. This is often effected by it being exhausted. The aqueous gas mixture (aerosol) which leaves the electrodes is fed at the output side to a water separator in which the water is separated from the remaining gas.

The separated water is here caught by a collection container and drained from time to time via a valve. When the fuel cell is operating at below the freezing point of water, ice can form in the region of the collection container and the valve. Water separators, collection containers, and valves can be damaged or destroyed because of the very high compressive forces which occur as a result. The risk of ice forming is particularly great when the fuel cell is switched off. In order to avoid the formation of ice, the relevant components can be heated electrically of by means of a heat transfer fluid. However, the technical infrastructure required for this is complex, expensive, and prone to faults.

### SUMMARY

The teachings of the present disclosure include water separation methods and/or devices for a fuel cell characterized by improved operational reliability even at temperatures below the freezing point of water with simultaneously low costs and low technical complexity. For example, some embodiments include a water separation device (400) for a fuel cell (3), comprising: a separation mechanism (430) for separating water from an aqueous gas mixture discharged from the fuel cell (3), a container (440) with a collection volume (441) for collecting the water separated by the separation mechanism (430), and a freeze protection mechanism (4500) with a displaceable valve mechanism (4510) which is coupled to the collection volume (441), wherein the freeze protection mechanism (4500) is designed in such a way that, when the water (600) in the collection volume (441) freezes, the valve mechanism (4510) moves in the direction of a freeze position with an enlargement of the collection volume (441), and that, when the frozen water (600) in the collection volume (441) melts, the valve mechanism (4510) moves back in the direction of a melt position with a reduction of the collection volume (441).

In some embodiments, there is a drainage duct (4600) for draining the liquid water, separated in the water separation device (400), by means of the valve mechanism (4510).

In some embodiments, the drainage duct (4600) is formed in a boundary wall (442) of the container (440) and is fluidically coupled to the valve mechanism (4510).

In some embodiments, the freeze protection mechanism (4500) has a restoring mechanism (4520) for exerting a restoring force, directed in the direction of the melt position, on the valve mechanism (4510), wherein, when the valve mechanism (4510) moves in the direction of the freeze position, the restoring force is amplified, and wherein, when the valve mechanism (4510) moves in the direction of the melt position, the restoring force is reduced.

In some embodiments, the restoring mechanism (4520) has at least a mechanical spring, an elastomer, or a gas-pressure spring which is coupled to the valve mechanism (4510) in a manner allowing force to be transmitted.

In some embodiments, the container (400) has an aperture (445) in a boundary wall (440), and wherein the valve mechanism (4510) is arranged displaceably in the aperture (445), and wherein the restoring mechanism (4520) is arranged on that side of the valve mechanism (4510) facing away from the collection volume (441).

As another example, some embodiments include a fuel cell device (2) comprising: a fuel cell (3) which has an anode mechanism (4) and a cathode mechanism (5), wherein the anode mechanism (4) has an anode output (41) for discharging an aqueous gas mixture from the anode mechanism (4), and wherein the cathode mechanism (5) has a cathode output (51) for discharging an aqueous gas mixture from the cathode mechanism (5), and at least one water separation device (400) as described herein, which is coupled to the anode output (41) and/or the cathode output (51).

### BRIEF DESCRIPTION OF THE DRAWINGS

The teachings of the present disclosure are explained in more detail below on the basis of exemplary embodiments and with reference to the appended drawings, in which:

FIG. 1 shows a schematic illustration of a fuel cell device for a motor vehicle incorporating teachings of the present disclosure;

FIG. 2 shows a schematic illustration of a fuel cell and the associated water separation devices incorporating teachings of the present disclosure;

FIGS. 3-4 show schematic illustrations of the fundamental structure and the fundamental operating principle of a freeze protection mechanism incorporating teachings of the present disclosure; and

FIGS. 5-7 show schematic illustrations of various exemplary embodiments of a freeze protection mechanism incorporating teachings of the present disclosure.

### DETAILED DESCRIPTION

Some embodiments of the teachings herein include a water separation device for a fuel cell comprising a separation mechanism for separating water from an aqueous gas mixture discharged from the fuel cell. Also part of the water separation device is a container with a collection volume for collecting or catching the water separated by the separation mechanism. Also part of the water separation device is a freeze protection mechanism with a movable or displaceable valve mechanism for draining water from the collection volume, wherein the valve mechanism is coupled to the collection volume in a manner allowing compressive force to be transmitted, wherein the freeze protection mechanism is designed in such a way that, when the water in the collection volume freezes, the valve mechanism moves in the direction of a freeze position with an enlargement of the collection volume, and that, when the frozen water in the collection volume melts, the valve mechanism moves back in the direction of a melt position with a reduction of the collection volume.

Ice has a specific volume which is approximately 8-10% greater than that of water. If the water which has been collected in the container freezes and becomes ice, very high compressive forces result if it is not possible for the ice to expand or the volume to be sufficiently compensated. The teachings of the present disclosure provide a freeze protection mechanism which enables variable volume compensation in the collection volume.

In other words, the freeze protection mechanism enables the collection volume to be enlarged as required in the event of the water in the collection volume turning to ice, and the collection volume to be correspondingly reduced in the event of the ice in the collection volume turning to water. The valve mechanism has two opposite surface sides. On one surface side, it is connected, in a manner allowing compressive force to be transmitted, to the collection volume and, depending on the filling level, to the water or ice which has collected therein.

On the other surface side, the valve mechanism is connected, in a manner allowing force to be transmitted, to the surroundings (atmospheric pressure, ambient air). In some embodiments, the valve mechanism can also be coupled on the other surface side to a restoring mechanism which exerts a force on it which is directed counter to the force at the collection volume (see claim 2). The valve mechanism is mounted so that it can move or be displaced along a displacement path. It assumes along this displacement path a position in which the forces which act on it on opposite surface sides are in equilibrium. If water is situated in the collection volume, the valve mechanism is situated in a melt position. If the water in the collection volume then freezes, this causes a one-sided increase in the compressive force on the valve mechanism. The valve mechanism then moves along the displacement path in the direction of the freeze position in which equilibrium of forces is then restored.

If the ice in the collection volume melts, because the volume of the ice shrinks, this causes a one-sided lowering of the compressive force on the valve mechanism at the collection volume (for example, because of the evacuation effect in the space between the valve mechanism and the melting ice). The valve mechanism then moves along the displacement path in the direction of the melt position until equilibrium of forces is restored. The freeze protection mechanism is dimensioned in such a way that the enlargement of the collection volume is sufficiently large to avoid damage to the water separation device because of the formation of ice.

For example, the freeze protection mechanism can be designed or dimensioned in such a way that the collection volume can widen or enlarge by at least 8% when ice forms. As a result, damage to the water separation device can be reliably avoided when ice forms inside the collection volume. The operational reliability of the water separation device is consequently ensured even at temperatures below the freezing point.

The costs and the susceptibility to failure are low. Electrical or fluid-based heating can be dispensed with, which significantly reduces the costs, the technical complexity, and the susceptibility to failure of the water separation device. By using the valve mechanism as part of the freeze protection mechanism, it takes on a dual function, which minimizes the costs, the number of components, and the construction complexity.

In some embodiments, the water separation device has a drainage duct for draining the liquid water, separated in the water separation device, by means of the valve mechanism. For example, in one embodiment, the drainage duct is formed in a boundary wall of the container and is fluidically coupled to the valve mechanism. The drainage of the water can thus be particularly simple and/or the water separation device be particularly robust and/or cost-effective.

In some embodiments, the freeze protection mechanism has a restoring mechanism, coupled to the valve mechanism in a manner allowing force to be transmitted, for exerting a restoring force, directed in the direction of the melt position, on the valve mechanism, wherein, when the valve mechanism moves in the direction of the freeze position, the restoring force is amplified, and wherein, when the valve mechanism moves in the direction of the melt position, the restoring force is reduced.

In some embodiments, a restoring mechanism ensures the backward movement of the valve mechanism into the melt position. It is moreover possible to adjust the restoring force by a corresponding choice of the restoring mechanism. The restoring mechanism can here, according to one embodiment, have a mechanical spring (for example, made from metal or plastic), an elastomer (for example, rubber) or a gas-pressure spring which is coupled to the valve mechanism in a manner allowing force to be transmitted.

These are very efficient, reliable, and cost-effective structures of the restoring mechanism which, by a corresponding choice of the geometry and the materials used, enable adaptation of the restoring force by a corresponding choice of materials and dimensioning.

In some embodiments, the container has a cavity at a boundary wall, wherein the valve mechanism is arranged displaceably in the cavity, and wherein the restoring mechanism is arranged on that side of the valve mechanism facing away from the collection volume.

In some embodiments, a fuel cell device comprises:
a fuel cell which has an anode mechanism and a cathode mechanism, wherein the anode mechanism has an anode output for discharging an aqueous gas mixture from the anode mechanism, and wherein the cathode mechanism has a cathode output for discharging an aqueous gas mixture from the cathode mechanism, and
at least one water separation device as described herein coupled to the anode output and/or to the cathode output.

With regard to the advantages of this fuel cell device, reference is made to the configuration for the water separation device, which advantages similarly also apply for the fuel cell device.

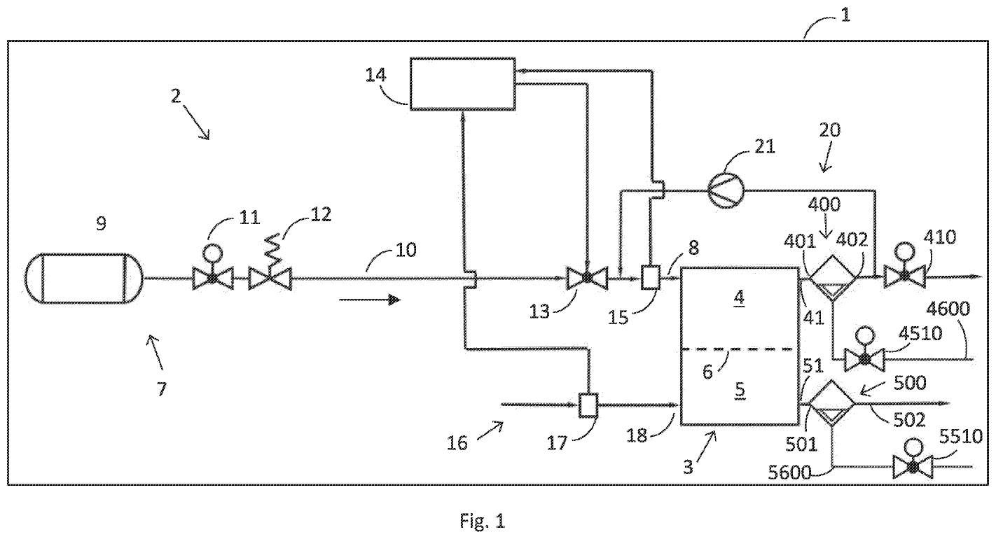

A motor vehicle 1 with an exemplary fuel cell device 2 incorporating teachings of the present disclosure is schematically illustrated in FIG. 1. The fuel cell device 2 includes a fuel cell 3 which functions as a galvanic cell. The fuel cell 3 has an anode mechanism 4 and a cathode mechanism 5 which are separated from each other by an electrolyte mechanism 6 (ion conductor). The electrolyte mechanism 6 can be designed, for example, as a polymer electrolyte membrane which is permeable only for protons but not for electrons.

In some embodiments, specific ceramics or other solid electrolytes can also be used. The anode mechanism 4 and the cathode mechanism 5 have electrode plates or bipolar plates (not illustrated) which may be manufactured from metal or carbon and are coated with a catalyst such as, for example, platinum or palladium.

Also part of the fuel cell device 2 is a fuel supply mechanism 7 which is coupled to an input 8 of the anode mechanism 4 in order to supply the latter with fuel. The fuel supply mechanism 7 has a fuel tank 9 in which the fuel is stored. In the exemplary embodiment, the fuel used is hydrogen which is stored in liquid or gaseous form under very high pressure (for example, 350 bar to 700 bar) in the fuel tank 9. The fuel tank 9 is connected to the input 8 of the anode device 4 via a supply line 10. A shut-off valve 11 and a pressure reducer 12 are arranged one behind the other in the supply line 10 downstream (arrow) from the fuel tank 9. The pressure reducer 12 reduces the gas pressure to approximately 10 bar to 30 bar.

An electrically actuated metering valve 13, by means of which targeted metering of the hydrogen into the anode mechanism 4 is possible, is provided further downstream in the supply line 10. Control of the metering valve 13 is effected here by a control device 14, assigned to the fuel cell device 2, which is electrically connected to the metering valve 13. A pressure sensor 15, which is connected to the control device 14 and supplies to the latter the hydrogen pressure value at the input 8 of the anode mechanism 4, is moreover arranged between the metering valve 14 and the anode mechanism 4. The pressure inside the anode mechanism 4 fluctuates in the range between 0.8 bar and 4 bar when the fuel cell 3 is operating.

Also part of the fuel cell device 2 is an oxidizing agent supply mechanism 16 which is coupled to the cathode mechanism 5 in order to supply the latter with oxidizing agent. In the exemplary embodiment, atmospheric oxygen is used as the oxidizing agent which is fed to the cathode mechanism 5 by the oxidizing agent supply mechanism 16. In order to ensure that the oxygen pressure in the cathode mechanism 5 is sufficiently high, the oxidizing agent supply mechanism 16 has a further pressure sensor 17 which delivers the oxygen pressure or the atmospheric pressure to the control device 14 at the input 18 of the cathode mechanism 5.

The hydrogen at the anode mechanism 4 reacts with the atmospheric oxygen at the cathode mechanism 5 with the formation of water, wherein a flow of direct current occurs between the anode mechanism 4 and the cathode mechanism 5. The direct current can be used to operate an electric drive motor (not illustrated) of the motor vehicle 1.

Over time, parts of the nitrogen and water diffuse from the cathode mechanism 5, through the polymer electrolyte membrane 6, to the anode mechanism 4. However, the diffusion of these two substances is undesirable because these substances block the supply ducts for the hydrogen and moreover prevent a uniform distribution of the hydrogen over the whole membrane surface.

In order to maintain the effectiveness and efficiency of the fuel cell, the respective reaction products are discharged from the anode mechanism 4 and the cathode mechanism 5. To do this, the anode mechanism 4 has an anode output 41 via which the reaction products can be evacuated, i.e. discharged, from the anode mechanism 4. The reaction products at the anode mechanism 4 are essentially a gas mixture of steam, nitrogen, and hydrogen as the main components.

The cathode mechanism 5 has a cathode output 51 via which reaction products can be evacuated, i.e. discharged, from the cathode mechanism 5. The reaction products at the cathode mechanism 5 are usually a gas mixture of steam, nitrogen, and hydrogen as the main components.

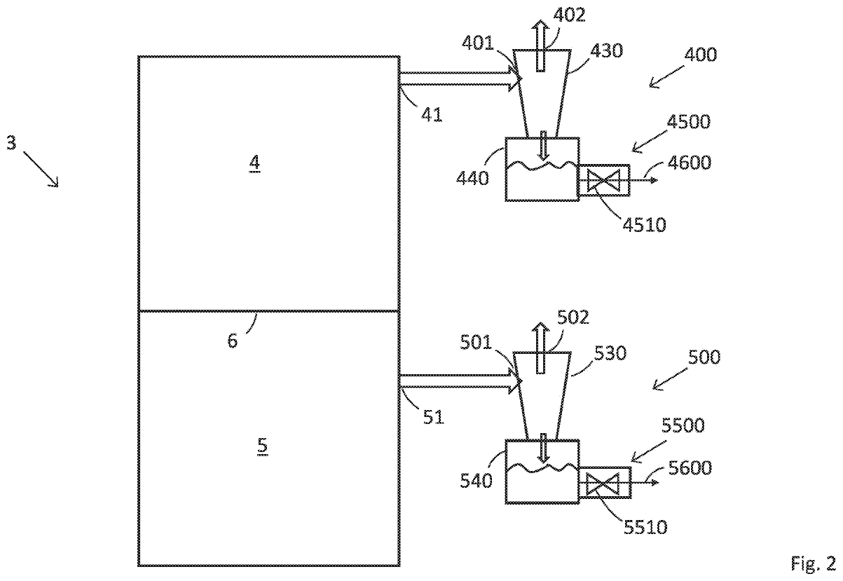

As can be seen in FIG. 1 in conjunction with FIG. 2, the exemplary embodiment of the fuel cell device 2 has a first water separation device 400 with which the anode mechanism 4 is associated. The first water separation device 400 has a first gas input 401 which is fluidically coupled to the anode output 41. The first water separation device 400 is designed to separate water from the aqueous gas mixture which escapes from the anode output 41. Whilst the separated liquid water remains at least temporarily in the first water separation device 400, the separated gas components leave the first water separation device 400 directly after the separation process via a first gas output 402. The separated gas components are then selectively fed back via a recirculation path 20 with a fan 21 arranged therein to the input of the anode mechanism 4 or drained into the surroundings via a controllable first gas valve 410. The liquid water separated in the first water separation device 400 can from time to time be drained via a controllable first valve mechanism 4510, associated with the first water separation device 400, and a first drainage duct 4600.

In the exemplary embodiment, the fuel cell device 2 has a second water separation device 500 with which the cathode mechanism 5 is associated. The second water separation device 500 has a second gas input 501 which is fluidically coupled to the cathode output 51. The second water separation device 500 is designed to separate water from the aqueous gas mixture which escapes from the cathode output 51. Whilst the separated liquid water remains at least temporarily in the second water separation device 500, the separated gas components leave the second water separation device 500 directly after the separation process via a second gas output 502 into the surroundings. The liquid water separated in the second water separation device 500 can from time to time be drained via a controllable second valve mechanism 5510, associated with the second water separation device 500, and a second drainage duct 5600. In some embodiments, just one water separation device can also be provided which is associated either with the anode mechanism 4 or the cathode mechanism 5.

As is shown schematically in FIG. 2, the first water separation device 400 has a first separation mechanism 430 for separating water from the aqueous gas mixture discharged from the anode mechanism 4, a first container 440 for collecting the separated water, and a first freeze protection mechanism 4500.

As is furthermore shown schematically in FIG. 2, the second water separation device 500 likewise has a second separation mechanism 530 for separating water from the aqueous gas mixture discharged from the cathode mechanism 5, a second container 540 for collecting the separated water, and a second freeze protection mechanism 5500.

The first separation mechanism 430 and the second separation mechanism 530 can be designed, for example, as a cyclone separator. The first container 440 or the second container 540 can be designed as integral with the first water separation device 400 or with the second water separation device 500, or as separate components.

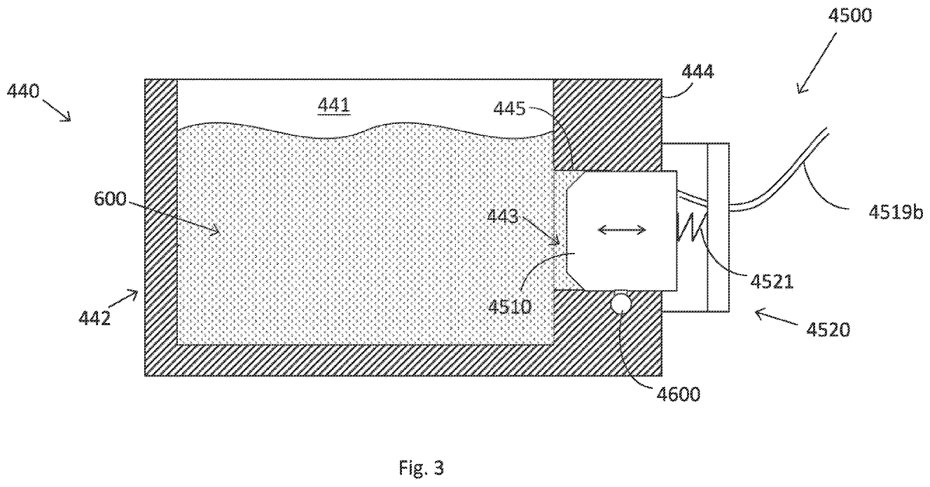

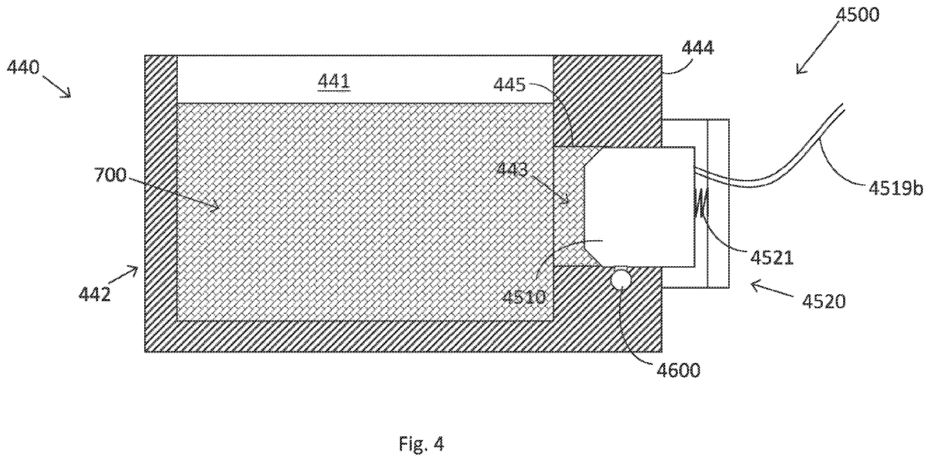

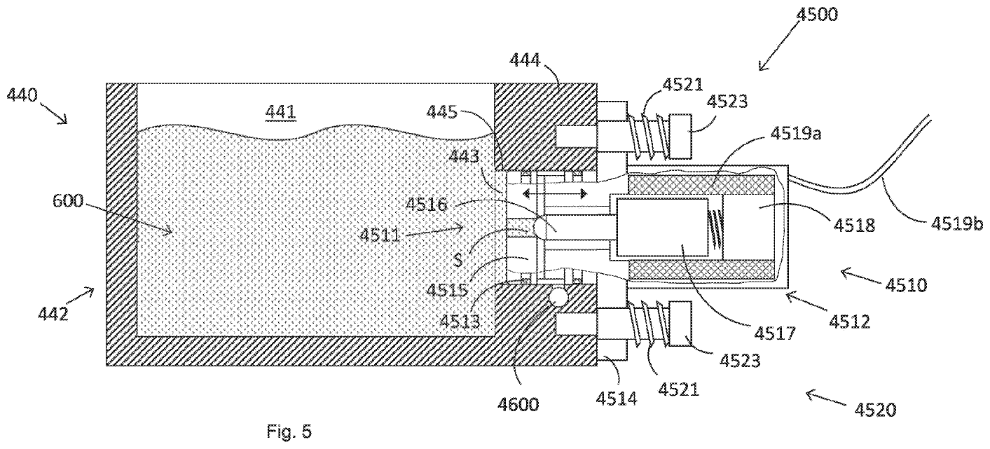

Exemplary embodiments of the first freeze protection mechanism 450 and parts of the first water separation device 400 are illustrated schematically in FIGS. 3 to 7. The structure and the operating principle of just the first freeze protection mechanism 450 are described below. The entire contents of the description can, however, similarly be transferred to the second freeze protection mechanism 550 with the same structure. The fundamental mode of operation and the fundamental structure of the first freeze protection mechanism 450 will be described on the basis of FIGS. 3 and 4. Specific structural exemplary embodiments will be described on the basis of FIGS. 5 to 7, wherein the fundamental mode of operation and the fundamental structure are also relevant for these exemplary embodiments.

In FIGS. 3 and 4, the first container 440 of the first water separation device 400 has a first collection volume 441 which is bounded by a boundary wall 442. The first water separation device 400 is depicted in FIG. 3 in a state in which water 600 has already collected in the first collection volume 441.

A cavity 443 is formed in the boundary wall 442 of the first container 440. To do this, an aperture 445, which is sealed liquidtightly or gastightly from the surroundings by the first freeze protection mechanism 4500, is formed in the boundary wall 442. The first freeze protection mechanism 4500 can be attached to the boundary wall 442 of the first container 440 by a screw, adhesive, or welded connection.

Part of the first freeze protection mechanism 4500 is the first valve mechanism 4510 which is illustrated purely schematically in FIGS. 3 and 4. The first valve mechanism 4510 is arranged in the cavity 443 or in the aperture 445 and mounted there so that it can be displaced or move or slide along a displacement path (double-headed arrow). The first valve mechanism 4510 is coupled in a manner allowing compressive force to be transmitted on a surface side to the water situated in the collection volume 441. In the exemplary embodiment, this surface side is directly in contact with the water 600. On the opposite surface side, the first valve mechanism 4510 is coupled in a manner allowing compressive force to be transmitted to a restoring mechanism 4520 of the first freeze protection mechanism 4500. The coupling is effected by means of which one or more coupling elements 4521 which are associated with the restoring mechanism 4520. Water 600 can be drained by means of the first valve mechanism 4510 from the collection volume 441 via the first drainage duct 4600 which is formed in the boundary wall 442 of the first container 440 and is fluidically coupled to the valve mechanism 4510.

The water 600 situated in the collection volume 441 is present in liquid form in FIG. 3. The first valve mechanism 4510 is situated along the displacement path in a melt position. In the melt position, the first valve mechanism 4510 is in a stable equilibrium of forces in the direction of the displacement path. The forces acting on opposite surface sides cancel each other out.

In the case of ambient temperatures below the freezing point of water, the water 600 in the collection volume 441 can turn to ice, in particular when the fuel cell 3 is not operated for a relatively long period of time. Ice has a specific volume which is approximately 9% greater than that of liquid water. When the water 600 in the first collection volume 441 freezes, there is an increase in compressive force on the surface side, facing the first collection volume 441, of the first valve mechanism 4510. This temporary equilibrium of compressive forces causes a displacement or movement of the first valve mechanism 4510 from the melt position (FIG. 3) along the displacement path into a freeze position (FIG. 4) with an enlargement of the collection volume 441.

The water situated in the collection volume 441 has completely frozen into ice 700 in FIG. 4. The first valve mechanism 4510 is situated along the displacement path (double-headed arrow) in the freeze position. In the freeze position, the first valve mechanism 4510 is again in a stable equilibrium of forces in the direction of the displacement path. The compressive forces on opposite surface sides cancel each other out. The expansion in volume is completed by the water turning to ice. The collection volume 441 in FIG. 4 is correspondingly larger than the collection volume in FIG. 3.

The restoring mechanism 4520 is coupled to the valve mechanism 4510 via the coupling elements 4521 in a manner allowing compressive force to be transmitted and is designed to exert a restoring force, directed in the direction of the melt position, on the valve mechanism 4510.

The restoring mechanism 4520 can be designed such that the restoring force is subject to a progression the further the valve mechanism 4510 moves from the melt position into the freeze position. The movement of the valve mechanism 4510 from the melt position in the direction of the freeze position is thus effected with the enlargement of the collection volume 441 and with an amplification of the restoring force.

If the ice 700 in the collection volume 441 then melts, the water 600 created assumes a smaller volume than that of the ice 700. The compressive force on the surface side, facing the collection volume 441, of the valve mechanism 4510 decreases and is now less than the restoring force exerted on the valve mechanism 4510 by the restoring mechanism 4520. By virtue of this disequilibrium of forces, the valve mechanism 4510 moves in the direction of the melt position (FIG. 3) until an equilibrium of forces is present again. The movement of the valve mechanism 4510 from the freeze position in the direction of the melt position is thus effected with the reduction of the collection volume 441 and with a weakening of the restoring force.

The first freeze protection mechanism 4500 enables adaptation of the first collection volume 441 as required depending on the state of aggregation of the water contained therein. In the event of the water contained in the first collection volume 451 turning to ice, the first freeze protection mechanism 4500 causes an enlargement of the first collection volume 441, as a result of which the ice which is created can expand sufficiently according to its relatively large specific volume without excessively large compressive forces being created which can result in damage to the first water separation device 400 or the first container 440. The first freeze protection mechanism 4500 is designed in such a way that the natural volumetric expansion which takes place when the water turns to ice is compensated by the enlargement of the first collection volume 441 to the extent that excessively high compressive forces and damage to the first water separation device 400 can be avoided. The freeze protection mechanism 4500 thus enables an enlargement of the collection volume 441 by approximately 9% to 16% in the event of the water turning to ice. Thus, when the valve mechanism 4510 is situated in the freeze position, the collection volume is, for example, approximately 9% to 16% larger than when the valve mechanism 4510 is situated in the melt position.

Exemplary embodiments of the freeze protection mechanism 4500 and the valve mechanism 4510 will now be described in detail on the basis of FIGS. 5 to 7. Only the structural aspects and modes of operation which go beyond the contents of the description of FIGS. 3 and 4 will be described here, wherein these are also valid.

A possible embodiment of the valve mechanism 4510 is illustrated in more detail in FIGS. 5 to 7. The valve mechanism 4510 projects with a valve portion 4511 into the aperture 445 formed in the boundary wall 444, and with a control portion 4512 to the outside via the boundary wall 444. A plurality of seals 4513 which seal the cavity 443 liquidtightly from the outside are provided on the external diameter of the valve portion 4511, wherein the displaceability of the valve mechanism 4510 continues to be ensured. At the transition between the valve portion 4511 and the control portion 4512, the valve mechanism 4510 has a boundary plate 4514 which extends radially (transversely to the direction of displacement of the valve mechanism 4510) outward. The valve mechanism 4510 remains with its control portion 4512 and the boundary plate 4514 outside the container 440 and in the melt position is applied against the boundary wall 444 with the boundary plate 4514.

A valve plate 4515 with a flow duct S is arranged in the valve portion 4511, wherein a valve seat is formed on that side of the valve plate 4515 facing away from the collection volume 441, at the rim of the flow duct S. A movable valve body 4516 is moreover arranged in the valve portion 4511. In the closed state of the valve mechanism 4510, said movable valve body bears against the valve seat 4515 in a liquidtight fashion. In the open state of the valve mechanism 4510, the valve body 4516 lifts off from the valve seat 4515 and frees the flow duct S such that water can flow from the collection volume 441 through the flow duct S. In the open state, the flow duct S is fluidically connected to the drainage duct 4600 which, in FIGS. 5-7, runs partially at the radial outer rim of the valve mechanism 4510 and partially in the boundary wall 444 of the container 440 such that water can be discharged from the container 440 via the flow duct S and the drainage duct 4600.

The valve mechanism 4510 is designed as an electromagnetic valve. An electromagnetic actuator which has an armature 4517 connected to the valve body 4516, a coil winding 4519a surrounding the armature 4517, and a pole piece 4518 is provided in the control portion 4512. Current/voltage can be applied to the coil winding 4519a by means of the current supply line 4519b in order thus to open and close the valve mechanism 4510. The valve mechanism 4510 is mounted in sliding fashion at its plate-like portion 4510a on two threaded bolts 4523 which are fastened to the container wall 444.

In the exemplary embodiments of FIGS. 5 to 7, the restoring mechanism 4520 has the two or more threaded bolts 4523, which are fastened to the container wall 444, and two mechanical springs as coupling elements 4521 which are placed over the shafts of the threaded bolts 4523. The mechanical springs 4521 can be designed as helical springs or cup springs made from metal or plastic. The valve mechanism 4510 is mounted in sliding fashion with its boundary plate 4514 on two or more threaded bolts 4523. For this purpose, the boundary plate 4514 is provided with a plurality of through bores through which the shafts of the threaded bolts 4523 penetrate. The mechanical springs 4521 are supported at one of their ends on the heads of the threaded bolts 4523 and at their opposite ends on the boundary plate 4514 of the valve body 4510. The valve mechanism 4510 is thus coupled to the restoring mechanism 4520 elastically and in a manner allowing force to be transmitted, wherein the restoring force is amplified (mechanical springs are compressed and consequently tensioned) when the valve mechanism 4510 moves in the direction of the freeze position, and is reduced (mechanical springs are relaxed) in the opposing direction of movement. The heads of the threaded bolts 4523 act as mechanical stops and delimit the movement stroke of the valve mechanism 4510.

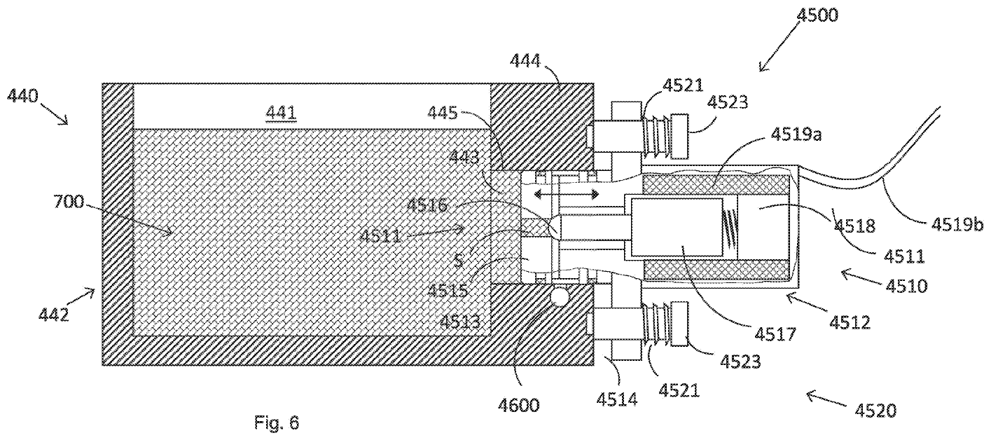

The water situated in the collection volume 441 is present in liquid form in FIG. 5. The valve mechanism 4510 is situated in the melt position. The mechanical springs 4521 are relaxed or only slightly compressed. If the water 600 in the collection volume now freezes, because of the volumetric expansion a displacement of the valve mechanism 4510 occurs in the direction of the freeze position with enlargement of the collection volume 441. The valve mechanism 4510 slides under compression of the mechanical springs 4521 in the direction of the heads of the threaded bolts 4523. The water 600 situated in the collection volume 441 has completely frozen in FIG. 6. The valve mechanism 4510 is situated in the freeze position. The mechanical springs 4521 are highly compressed and generate a restoring force which forces the valve mechanism 4510 into the melt position. As soon as the water situated in the collection volume 441 melts again with a reduction of the volume, the mechanical springs 4521 force the valve mechanism 4510 back into the melt position.

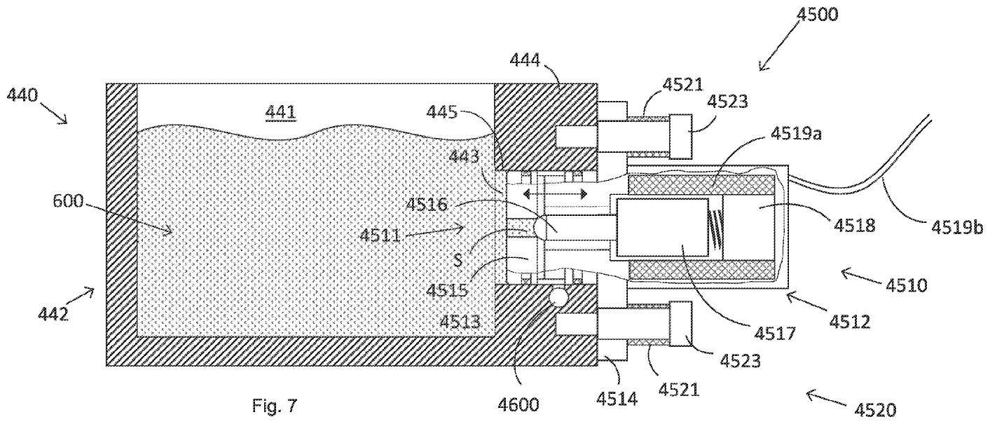

The exemplary embodiment in FIG. 7 differs from the exemplary embodiment in FIGS. 5 and 6 only in that two sleeve-shaped elastomers are provided as coupling elements 4521 which also function as springs. Otherwise, the operating principle is similar to the exemplary embodiment of FIGS. 5 and 6.

What is claimed is:

1. A water separation device for a fuel cell, the device comprising:
a separator for separating water from an aqueous gas mixture discharged from the fuel cell;
a container defining a collection volume to collect the water from the separator; and
a freeze protector including a displaceable valve coupled to the collection volume,
wherein, when the water in the collection volume freezes, the valve moves in the direction of a freeze position enlarging the collection volume, and
when frozen water in the collection volume melts, the valve moves back in the direction of a melt position reducing the collection volume.

2. The water separation device as claimed in claim 1, further comprises a drainage duct to drain liquid water separated in the water separation device using the valve mechanism.

3. The water separation device as claimed in claim 2, wherein the drainage duct is formed in a boundary wall of the container and is fluidically coupled to the valve mechanism.

4. The water separation device as claimed in claim 1, wherein:
the freeze protection mechanism includes a restoring mechanism to exert a restoring force directed toward the melt position, on the valve;
when the valve moves in the direction of the freeze position, the restoring force is amplified; and
when the valve moves in the direction of the melt position, the restoring force is reduced.

5. The water separation device as claimed in claim 4, wherein the restoring mechanism includes at least one of: a mechanical spring, an elastomer, or a gas-pressure spring coupled to the valve allowing force to be transmitted.

6. The water separation device as claimed in claim 1, wherein:
the container has an aperture in a boundary wall;
the valve is arranged displaceably in the aperture; and
the restoring mechanism is arranged on a side of the valve facing away from the collection volume.

7. A fuel cell device comprising:
a fuel cell with an anode mechanism and a cathode;
wherein the anode has an anode output to discharge an aqueous gas mixture from the anode, and the cathode has a cathode output to discharge an aqueous gas mixture from the cathode;
a separator for separating water from an aqueous gas mixture discharged from the anode output and/or the cathode output;
a container defining a collection volume to collect the water from the separator; and
a freeze protector including a displaceable valve coupled to the collection volume,
wherein, when the water in the collection volume freezes, the valve moves in the direction of a freeze position enlarging the collection volume, and
when frozen water in the collection volume melts, the valve moves back in the direction of a melt position reducing the collection volume.
